(19) United States
(12) Patent Application Publication
(10) Pub. No.: US 2015/0068775 A1
(43) Pub. Date: Mar. 12, 2015

(54) FIRE PROTECTION SPRINKLER SYSTEM WITH MODIFIED SPRINKLER HEADS

(71) Applicant: Oneil Barrett, Philadelphia, PA (US)

(72) Inventor: Oneil Barrett, Philadelphia, PA (US)

(21) Appl. No.: 14/283,526

(22) Filed: May 21, 2014

Related U.S. Application Data
(60) Provisional application No. 61/874,483, filed on Sep. 6, 2013.

(51) Int. Cl. A62C 3/02; B05B 1/14; B05B 3/10; A62C 35/68; A62C 35/64

(52) U.S. Cl. CPC A62C 3/0214; A62C 35/68; A62C 35/64; B05B 3/10; B05B 1/14
USPC 169/13; 169/16

(57) ABSTRACT

A fire protection sprinkler system with modified sprinkler heads compromising a water supply; a network of hosing connected to the water supply; a plurality of sprinkler heads placed along the network hosing, where the each of the plurality of sprinkler heads include a series of water stream emission points; and multiple streams of water emitted from the water stream emission points, where each stream is emitted at a different angle.

### CROSS REFERENCE TO OTHER APPLICATIONS

This application claims priority to U.S. Provisional Application Ser. No. 61/874,483 filed on Sep. 6, 2013.

### BACKGROUND OF THE INVENTION

1. Field of the Invention

The present invention relates to a fire protection system that includes sprinkler heads with a modified sprinkler that emits several streams of water during operation.

2. Description of Related Art

Fire protection is essential due to the risks and damage associated with fires. Various forms of fire protection include alarms, sprinkler systems, smoke detectors and carbon monoxide detectors. These forms of fire protection and detection are used in various degrees in order to prevent property damage and injury. Many heavily wooded and rural areas are especially at risk when property is located in the close proximity of these areas. Homes and buildings near wooded areas may suffer significant damage if a fire were to start in a wooded area and spread in to a developed area. Although a general or conventional smoke or fire detection and other suppression methods are available it will be advantageous to have the use of improved sprinkler systems for residential and small building protection. These sprinkler systems may reduce the amount of property damage and therefore provide an alternative means for fire protection.

### SUMMARY OF THE INVENTION

In view of the foregoing disadvantages inherent in the prior art, the general purpose of the present invention is to provide a fire protection sprinkler system with modified sprinkler heads, configured to include all of the advantages of the prior art, and to overcome the drawbacks inherent therein.

Accordingly, an object of the present invention is to provide a fire protection sprinkler system with sprinkler head that emit water at various angles thereby providing a widespread distribution of water.

Another object of the present invention is to provide a fire protection sprinkler system that may pull water from a natural body of water or a manmade water reservoir enabling use in any location with an available water supply.

To achieve the above objects, in an aspect of the present invention, a fire protection sprinkler system with sprinkler heads is described compromising a water supply; a network of hosing connected to the water supply; a plurality of sprinkler heads placed along the network hosing, where the each of the plurality of sprinkler heads include a series of water stream emission points; and multiple streams of water emitted from the water stream emission points, where each stream is emitted at a different angle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a sprinkler head in accordance with an exemplary embodiment of the present invention;

FIG. 2 depicts a perspective view of an assembly for stabilizing a sprinkler head in accordance with an exemplary embodiment of the present invention;

FIG. 3(A) depicts a first means for water supply for a sprinkler system in accordance with an exemplary embodiment of the present invention; and

FIG. 3(B) depicts an alternative means for water supply for a sprinkler system for use of a portable system in accordance with an exemplary embodiment of the present invention.

Like reference numerals refer to like parts throughout the description of several views of the drawings.

### DETAILED DESCRIPTION OF THE DRAWINGS

The present invention relates to a fire protection sprinkler system that includes a modified sprinkler head that is installed over a network of hosing. The sprinkler system in accordance with the present invention provides an effective system to prevent fires and to limit property damage based upon use of the sprinkler system. The sprinkler system in accordance with the present invention may be electrically or solar powered and installed in a permanent fixed position through a network of hosing. Unique to this sprinkler system of the present invention is the sprinkler heads that are utilized along the system. The sprinkler heads include multiple streams of water that are emitted at various angles. This configuration allows the sprinkler head a larger circumference of emission and also more effective multiple streams of water over a wider surface area. The system may also be utilized in a portable form so that it may be installed in remote areas where the water supply can vary from a natural body of water such as a local river stream or lake. Further a water tank may be available for the water supply. In a fixed installation the water supply may be supplied through the municipal water lines.

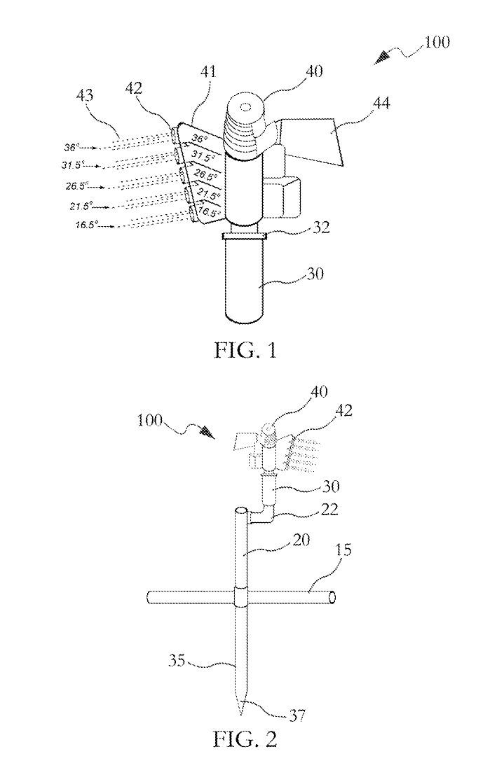

Turning now descriptively to the drawing FIG. 1 shows a sprinkler head 100 in accordance with an exemplary embodiment of the present invention. Sprinkler head 100 includes a head 40 with a spout 41. The spout 41 includes a series of water stream emission points 42. From the series of water stream emission points 42 a series of water streams 43 are emitted at various angles. FIG. 1 illustrates the various angles with the dotted lines coming from the water stream emission points 42. In this particular embodiment, five water streams 43 are emitted at the water stream emission points 42 at five angles. The angles may be 16.5 degrees, 21.5 degrees, 26.5 degrees, 31.5 degrees, and 36 degrees. The largest degree is placed at the top of the arrangement and the smallest degree is placed at the bottom of the arrangement. A neck 32 is provided that mounts and supports the sprinkler head 100. The neck 32 enables the sprinkler head 100 to rotate and spray water in a circular manner around the head 40. A balance 44 is provided on the opposite side of the water stream emission points 42. The sprinkler head 100 is mounted onto a sprinkler connection 30.

Referring now to FIG. 2, an expanded view of an assembly for stabilizing the sprinkler head 100 is shown. The depiction shows the connection of the sprinkler system to a hose 15. Hose 15 is a portion of a hose network that is used in a sprinkler system according to the present invention. Each sprinkler head 100 is firmly fixed in position with a mounting stake 35. The mounting stake 35 includes a spike tip 37 which facilitates the stake 35 driving into the ground during use. An arm 20 extends from the stake 35 with an elbow connector 22 attached to the sprinkler connection 30. Water flows from the hose 15 through the arm 20 into the sprinkler head 100. This configuration is repeated throughout the entire hose network so that sprinkler heads 100 are placed over a geographical area for widespread fire protection purposes. Fire detection systems may be provided within the system in order to detect smoke, fire or even heat sensors in order to activate the sprinkler system. Once activated water is emitted through the water stream emission points 42 provided on the sprinkler head 40.

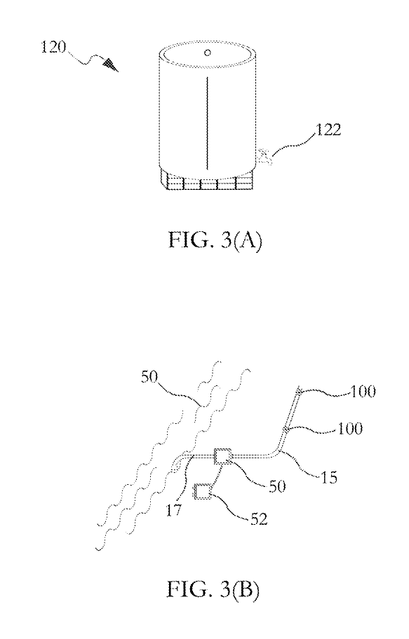

FIG. 3(A) illustrates a first means of water supply for a portable version of the sprinkler system according to the present invention. The first means may be a water tank 120 filled with water. The water tank 120 includes a spout 122 to which the hose 15 is connected. Alternatively FIG. 3(B) illustrates an alternative water supply provided by a river 50. As shown in FIG. 3(B), a supply end 17 transfers water from the river 50 through a motor power pump 50 in to the hose system 15. The pump or motor 50 receives power from a generator 52 in this particular embodiment. This demonstrates a portable embodiment of the present invention that utilizes the sprinkler heads 100 as shown in the previous figures. This particular system directs five streams of water over a geographical area and provides an effective means for fire suppression.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fire protection sprinkler system with modified sprinkler heads compromising:
a. a water supply;
b. a network of hosing connected to the water supply;
c. a plurality of sprinkler heads placed along the network hosing, where the each of the plurality of sprinkler heads include a series of water stream emission points; and
d. multiple streams of water emitted from the water stream emission points, where each stream is emitted at a distinct angle.

2. The fire protection system according to claim 1, where the water supply is a natural body of water.

3. The fire protection system according to claim 2, where the natural body of water is one of at least a river, lake or stream.

4. The fire protection system according to claim 2, where the water supply includes a motor power pump powered by a generator to pull the water from the natural body of water into the system.

5. The fire protection system according to claim 1, where the water supply is one of at least a water tank, or a fixed municipal water supply.

6. The fire protection system according to claim 1, where each sprinkler head includes a sprinkler connection, where the sprinkler connection fastens the sprinkler head to the network of hosing.

7. The fire protection system according to claim 1, where each sprinkler head includes a neck, where the neck enables the sprinkler head to rotate and spray water in a circular manner.

8. The fire protection sprinkler system according to claim 1, where the multiple streams include five water streams.

9. The fire protection sprinkler system according to claim 8, where the five streams are emitted at angles ranging from about 16.5 degrees to about 35 degrees.
